(19) United States
(12) Patent Application Publication
(10) Pub. No.: US 2007/0229400 A1
(43) Pub. Date: Oct. 4, 2007

(54) Method and device for driving display device

(75) Inventor: Koichi Sakita, Akashi-shi (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Higashimorokata (JP)

(21) Appl. No.: 11/598,109

(22) Filed: Nov. 13, 2006

(30) Foreign Application Priority Data
Mar. 31, 2006 (JP) 2006-097313

(51) Int. Cl. G09G 3/28

(52) U.S. Cl. 345/60

(57) ABSTRACT

A method for driving a display device includes the steps of setting a plurality of light emission quantity control patterns for associating a measurement parameter having a value corresponding to brightness of each frame of an original image with a control parameter that determines light emission quantity of the entire screen of one frame, and performing the light emission quantity control by selectively using one of the plurality of light emission quantity control patterns that satisfies a preset selection condition in accordance with a sum of values of the measurement parameters determined for a plurality of frames.

### BACKGROUND OF THE INVENTION

1. Field of the Invention

The present invention relates to a method for driving a display device by controlling light emission quantity for saving power consumption and a driving device utilizing the method.

2. Description of the Prior Art

When a self light emission type display device including a plasma display panel and a cathode ray tube (CRT) is used for displaying images, power consumption increases along with increase of the number of pixels to emit light and light emission luminance (corresponding to a gradation value to be displayed). If the maximum luminance of individual pixels is a sufficiently large value, the power consumption becomes excessive when all the pixels emit light at the maximum luminance. Therefore, this type of display device usually has an auto power control (APC) function for controlling the power consumption below a preset value. Controlling the power is equal to controlling light emission quantity of the whole screen.

As the method of controlling the power, there is a method of adjusting a luminance level of an image signal (a so-called gain control) and a method of changing a relationship between the gradation value and the light emission quantity. Since the number of gradation levels is reduced in the gain control, it is preferable to change a relationship between the gradation value and the light emission quantity from a viewpoint of avoiding degradation of image quality.

When an AC type plasma display panel is used for displaying images, sustain pulses are applied to a cell of the screen the number of times corresponding to the gradation to be displayed. The sustain pulses generate display discharges for light emission. In a display of one frame, light emission quantity of each cell depends on the number of times of the display discharges generated in the cell, i.e., the number of sustain pulses that are applied (hereinafter referred to as the number of drive pulses). The power consumption of the plasma display panel is substantially proportional to a total sum of the light emission quantity of all cells. The number of drive pulses is a control parameter that determines light emission quantity of the entire screen.

The driving device of the plasma display panel controls the light emission quantity (i.e., the power consumption) by changing a value of the number of drive pulses in accordance with a display load factor. The “display load factor” is a measurement parameter having a value corresponding to brightness of each frame of an original image, and it is calculated based on a gradation value of a cell i in one frame. The driving device is provided with a light emission quantity control pattern in advance, which makes a relationship between a value of the display load factor and a value of the number of drive pulses. The driving device calculates a value of the display load factor for each frame and determines a value of the number of drive pulses in accordance with the light emission quantity control pattern. Although it is necessary to delay frame data for calculating the display load factor, the driving device naturally delays the frame by a frame memory so as to generate a plurality of sub frames for reproducing gradation. Therefore, it is possible to perform a feed forward control of the light emission quantity without adding a data delay circuit for calculating the display load factor.

Concerning the light emission quantity control for regulating power consumption, there are conventional techniques as follows.

Japanese unexamined patent publication No. 2001-306026 discloses a method for preventing burn-in of the screen, in which a light emission quantity control pattern is prepared for a still picture display separately from a light emission quantity control pattern for a moving picture display, and luminance for a still picture display is decreased. Japanese unexamined patent publication No. 2003-122297 discloses a method for preventing a flicker, in which light emission quantity is controlled based on a mean value of display load factors of two fields for an interlace display.

The conventional method described above has a problem that gradation reproduction capability for a moving image (picture) consisting of a series of frames is decreased because a bright image (frame) as a whole is displayed in low brightness as a whole when the light emission quantity is controlled so that the power consumption does not exceed a preset value. In particular, when the picture changes from a dark scene to a bright scene, an observer may feel the increase in luminance of the display as a slow change.

### SUMMARY OF THE INVENTION

An object of the present invention is to increase gradation reproducibility in an image display without increasing power consumption.

A method for driving a display device according to an aspect of the present invention includes the steps of setting a plurality of light emission quantity control patterns for associating a value of a measurement parameter having a value corresponding to brightness of each frame of an original image with a value of a control parameter that determines light emission quantity of the entire screen of one frame, and performing the light emission quantity control by selectively using one of the plurality of light emission quantity control patterns that satisfies a preset selection condition in accordance with a sum of values of the measurement parameters determined for a plurality of frames.

The driving method described above is based on that an image has a frequency distribution of display load factors. In general pictures, the display load factor of each frame is not a constant value, but the display load factor changes for each frame. Then, concerning a change of the display load factor in a period of a predetermined length, the frequency distribution of the display load factor usually has frequencies that decrease as departing from a medium value of the distribution. In other words, a frame whose display load factor is close to the center of the frequency distribution has a large appearance ratio, while a frame whose display load factor is far away from the center of the frequency distribution has a small appearance ratio.

Concerning a frame having a large appearance ratio, overall power consumption in a frequency distribution calculating period becomes excessive unless the power consumption is regulated. Therefore, it is necessary to control the light emission quantity so that the power consumption is restricted to a preset value. On the other hand, even if the regulation of the power consumption is loosened a little for a frame having a small appearance ratio, it does not affect so much the power consumption of the entire frequency distribution calculating period.

Therefore, a plurality of light emission quantity control patterns having different degrees of regulation of power consumption is prepared and is used selectively, so that gradation reproducibility of a picture display can be improved without excessive power consumption.

As the measurement parameter corresponding to brightness of a frame, a display load factor and an electric power (current) value can be used. If a sum of measurement parameter values in a plurality of frames is determined to the extent of knowing tendency of frequency distribution of the measurement parameter value, a mean value of the measurement parameter value (corresponding to a center value of the frequency distribution) can be calculated from the sum and the number of frames.

According to the present invention, gradation reproducibility of an image display can be enhanced without increasing power consumption.

### BRIEF DESCRIPTION OF THE DRAWINGS

FIG. 1 is a block diagram of a display device showing its structure according to an embodiment of the present invention.

FIG. 2 is a graph showing contents of a basic control of a light emission quantity control.

FIGS. 3A and 3B are graphs showing a first example of the light emission quantity control.

FIGS. 4A and 4B are graphs showing a second example of the light emission quantity control.

FIGS. 5A and 5B are graphs showing a third example of the light emission quantity control.

### DESCRIPTION OF THE PREFERRED EMBODIMENTS

The invention will now be described in detail with reference to the attached drawings.

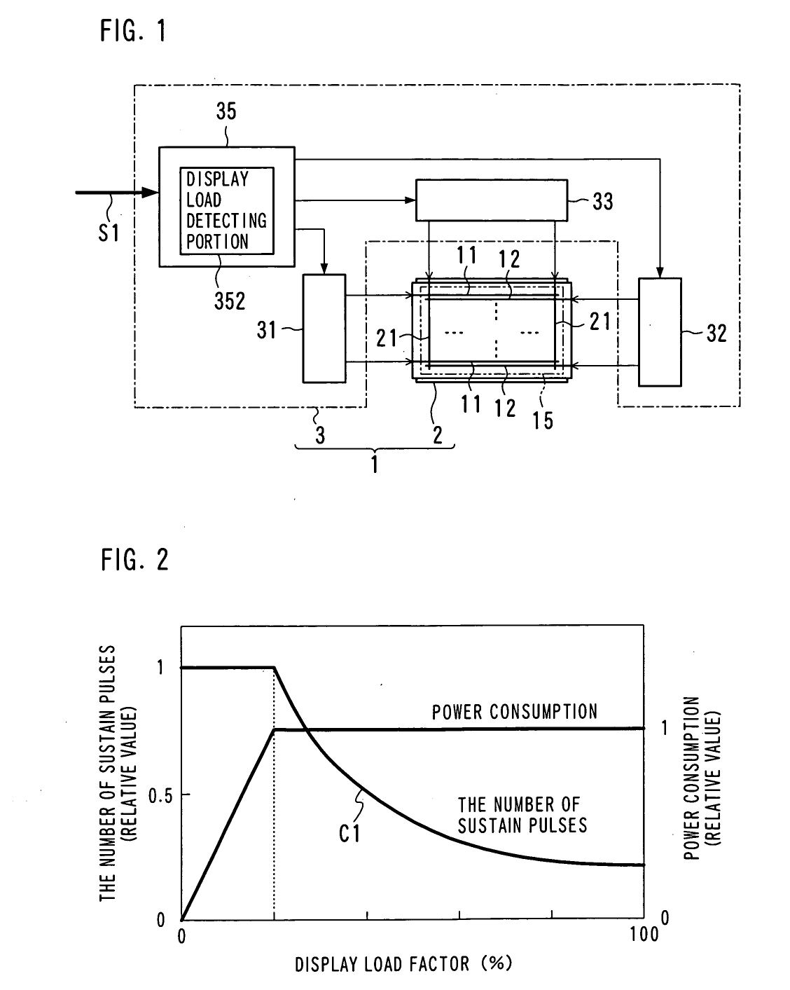

FIG. 1 is a block diagram of a display device showing its structure according to an embodiment of the present invention.

A display device 1 is made up of a plasma display panel 2 of a three-electrode surface discharge AC type having a screen 15 that is capable of displaying color images and a driving device 3 for driving the plasma display panel 2.

On the screen 15 of the plasma display panel 2, there are first electrodes 11 and second electrodes 12 arranged alternately as row electrodes, and third electrodes 21 are arranged as column electrodes. The first electrode 11 and the second electrode 12 constitute an electrode pair for generating a sustain discharge of a surface discharge type in each row. The third electrode 21 crosses the first electrode 11 and the second electrode 12 in each cell that belong to the column on which the third electrode 21 is disposed.

The driving device 3 includes a driving circuit 31 for applying a drive voltage to the first electrode 11, a driving circuit 32 for applying a drive voltage to the second electrode 12, a driving circuit 33 for applying a drive voltage to the third electrode 21, and a controller 35 for controlling application of the drive voltage to the plasma display panel 2. The controller 35 includes a display load detecting portion 352.

The driving device 3 is supplied with a color image signal S1 of a frame rate 1/30 seconds from an image output device such as a TV tuner or a computer. This color image signal S1 is converted into sub frame data by a data processing block of the controller 35 for the plasma display panel 2 to display the image.

The display load detecting portion 352 calculates a display load factor from a gradation value of each pixel of each frame indicated by the color image signal S1 (original image), and it accumulates the display load factors of a predetermined number of frames so as to calculate a mean value of them (an average display load factor). The display load factor is a mean value of ratios Gi/Gmax of all cells when the gradation value of a cell i in a frame is denoted by Gi (0≦Gi≦Gmax). The number of frames concerning the average display load factor is fixed (e.g., 30-300). The average display load factor is calculated and is updated for every input of one frame.

The controller 35 performs a light emission quantity control (automatic power control) for changing the number of sustain pulses (the number of drive pulses) applied to the plasma display panel 2 in each frame display in accordance with the display load factor. Although the sustain pulse is applied to all the cells at the same time in the plasma display panel 2, the cells to emit light are only cells in which a predetermined wall charge is formed prior to the application of the sustain pulse. The number of light emission cells in the entire screen is determined by the gradation value to be displayed corresponding to each cell, and the light emission quantity of one frame is determined by the gradation value and the number of sustain pulses to be applied. The light emission quantity control is a control that increases or decreases the number of sustain pulses.

FIG. 2 is a graph showing contents of a basic control of a light emission quantity control.

In the illustrated example, the light emission quantity control is not performed substantially when the display load factor is smaller than a predetermined value (20% in FIG. 2), and the number of sustain pulses in a display of one frame is set to a maximum number that can be applied within a time period determined by the frame period. In this case, the power consumption is substantially proportional to the display load factor. If the maximum number of sustain pulses are applied when the display load factor exceeds the predetermined value, the power consumption becomes excessive so that a problem of heat generation becomes serious. Therefore, if the display load factor exceeds the predetermined value, the number of sustain pulses is decreased along with increase of the display load factor as shown in FIG. 2 by the curve C1. Thus, the power consumption is controlled not to exceed a constant value. In other words, the curve C1 indicates a first light emission quantity control pattern that determines the number of sustain pulses in accordance with the display load factor so that the power consumption does not exceed the constant value even if the frame having a value of the display load factor within a predetermined range continues.

In the display device 1, a second light emission quantity control pattern that is partially different from the first light emission quantity control pattern is provided. The first light emission quantity control pattern and the second light emission quantity control pattern are selectively used as follows.

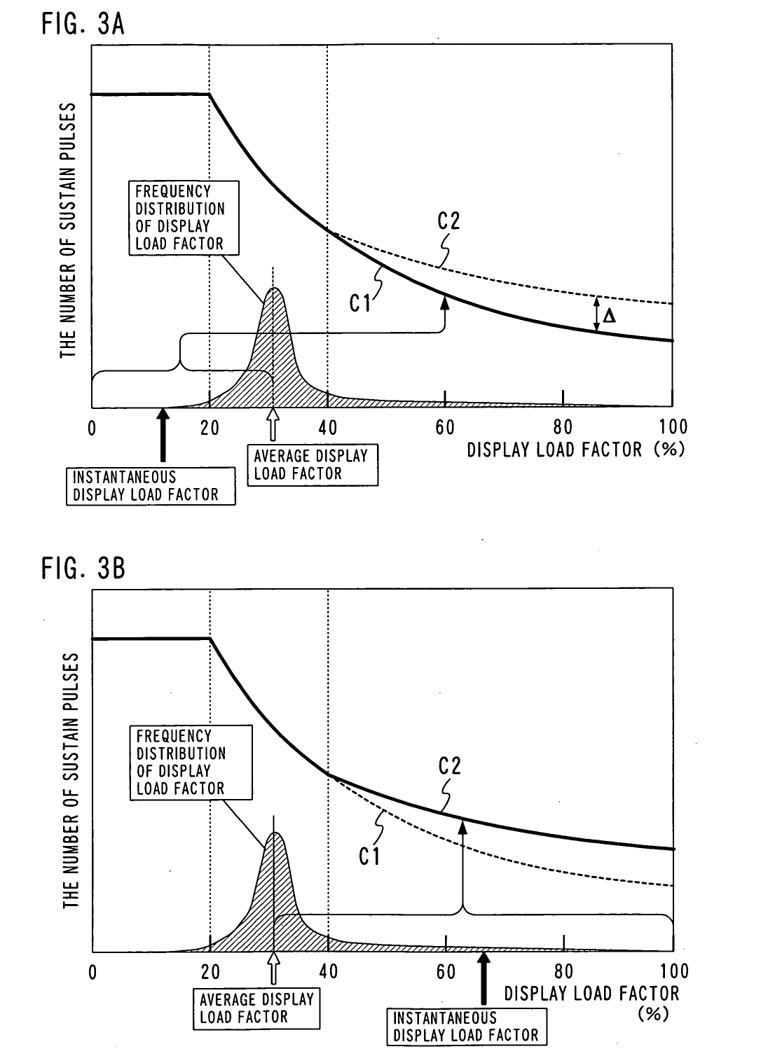

FIGS. 3A and 3B show a first example of the light emission quantity control. In FIGS. 3A and 3B, curves C1 and C2 that indicate the light emission quantity control patterns and graphics indicating a frequency distribution of the display load factor at a certain time point (a hatched part in FIGS. 3A and 3B) are drawn. In fact, the frequency distribution changes every moment. For example, if bright scenes continue, the center of the frequency distribution moves to the heavy load side gradually.

In FIGS. 3A and 3B, the second light emission quantity control pattern is shown by the curve C2. The second light emission quantity control pattern also decreases the number of sustain pulses as the display load factor increases basically in the same manner as the first light emission quantity control pattern. In the illustrated example, the first and the second light emission quantity control patterns are the same within the range 0-40% of the display load factor. However, if the display load factor exceeds 40%, a change of the number of sustain pulses in the second light emission quantity control pattern is gentle compared with a change of the number of sustain pulses in the first light emission quantity control pattern. In other words, the second light emission quantity control pattern has a characteristic that a value of the number of sustain pulses corresponding to a heavy load part in the range that includes possible display load factors is larger than the first light emission quantity control pattern. Further, there is a relationship between the second light emission quantity control pattern and the first light emission quantity control pattern, which is that a difference Δ between values of the number of sustain pulses increases as the display load factor increases.

When the second light emission quantity control pattern is used, the luminance of a bright part in the original image increases compared with the case where the first light emission quantity control pattern is used. However, if the second light emission quantity control pattern is used every time, the power consumption becomes excessive as described above. From this fact, in this example, the light emission quantity control pattern that is used for displaying the image is switched in accordance with a relationship between a value of the display load factor of the noted frame of which the number of sustain pulses is to be determined (this is referred to as an instantaneous display load factor for convenience) and a mean value of values of the display load factor that is determined based on a plurality of frames that are continuous before the noted frame (this is referred to as an average display load factor for convenience).

If the instantaneous display load factor is smaller than the average display load factor as shown in FIG. 3A, the first light emission quantity control pattern is used for displaying the noted frame. On the contrary, if the instantaneous display load factor is larger than the average display load factor as shown in FIG. 3B, the second light emission quantity control pattern is used for displaying the noted frame. Thus, a decrease of the gradation reproduction capability that is the problem in the conventional method can be improved, and a gradation change becomes vivid particularly in a transition from a dark scene to a bright scene.

In general, the average display load factor is approximately 30%. In other words, as shown in FIGS. 3A and 3B, appearance of frames having the average display load factor more than 40% are not many. Therefore, even by the simple control of selecting the pattern based on the comparison of the average display load factor with the instantaneous display load factor, increase of power consumption when the second light emission quantity control pattern is used is little such that there is no influence as a whole. However, in order to prevent a large increase of power consumption more securely, it is possible to use the second light emission quantity control pattern only in the case where the instantaneous display load factor is larger than the average display load factor by predetermined quantity. Alternatively, it is possible to use the second light emission quantity control pattern only in the case where the average display load factor is lower than or equal to the threshold level.

In this example, since the second light emission quantity control pattern is a pattern in which the difference Δ increases as the display load factor increases as described above, gradation reproduction capability can be improved by switching the smaller number of patterns than the pattern in which the difference Δ is constant.

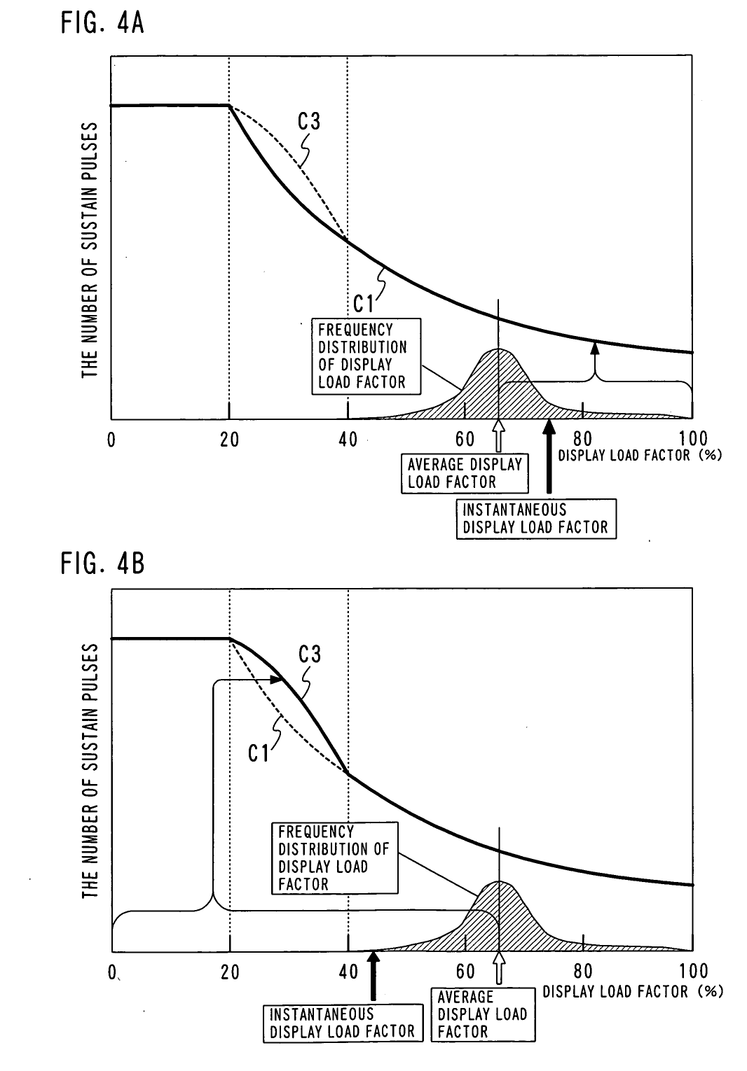

FIGS. 4A and 4B show a second example of the light emission quantity control.

In FIGS. 4A and 4B, a curve C3 indicates a third light emission quantity control pattern. Basically, the third light emission quantity control pattern also decreases the number of sustain pulses as the display load factor increases in the same manner as the first light emission quantity control pattern. In the illustrated example, within the range 40-100% of the display load factor, the first and the third light emission quantity control patterns are the same. However, within the range 20-40% of the display load factor, the relationship between the display load factor and the number of sustain pulses is different from the first light emission quantity control pattern. The third light emission quantity control pattern has a characteristic that a value of the number of sustain pulses corresponding to a light load part in the range that includes potential values of the display load factor is larger than that of the first light emission quantity control pattern.

If the third light emission quantity control pattern is used, luminance of a frame having a large appearance ratio (the instantaneous display load factor is 30) increases in general compared with the case where the first light emission quantity control pattern is used. However, if the third light emission quantity control pattern is used every time, the power consumption becomes excessive. Therefore, in this example too, the light emission quantity control pattern to be used for displaying the image is switched in accordance with a relationship between the instantaneous display load factor and the average display load factor.

If the instantaneous display load factor is larger than the average display load factor as shown in FIG. 4A, the first light emission quantity control pattern is used for displaying the noted frame. On the contrary, if the instantaneous display load factor is smaller than the average display load factor as shown in FIG. 4B, the third light emission quantity control pattern is used for displaying the noted frame.

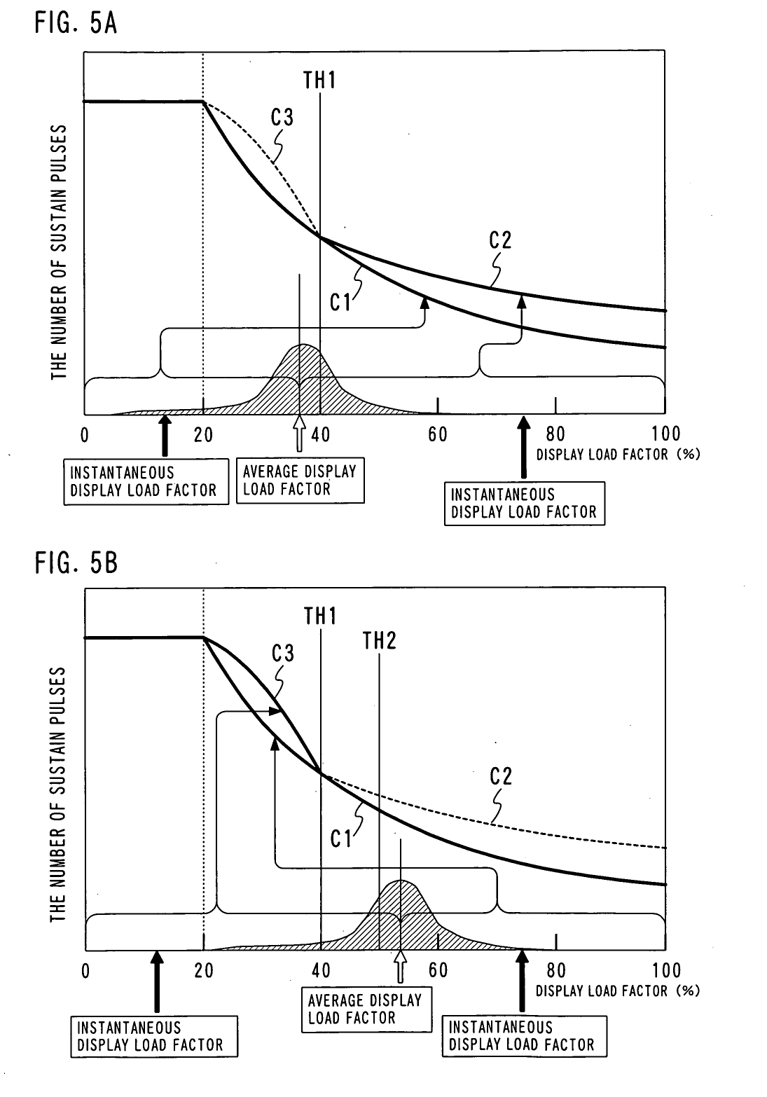

FIGS. 5A and 5B show a third example of the light emission quantity control.

In the third example, if the average display load factor is smaller than or equal to the first threshold level TH1 (40% in FIG. 5A) as shown in FIG. 5A and if the instantaneous display load factor is larger than the average display load factor, the second light emission quantity control pattern is used for displaying the noted frame. Further, if the average display load factor is smaller than or equal to the first threshold level TH1 and if the instantaneous display load factor is smaller than the average display load factor, the first light emission quantity control pattern is used for displaying the noted frame. Thus, the same effect as the first example described above can be obtained.

On the other hand, if the average display load factor is more than or equal to the second threshold level TH2 (50% in FIG. 5B) as shown in FIG. 5B and if the instantaneous display load factor is smaller than the average display load factor, the third light emission quantity control pattern is used for displaying the noted frame. Further, if the average display load factor is larger than or equal to the second threshold level TH2 and if the instantaneous display load factor is larger than the average display load factor, the first light emission quantity control pattern is used for displaying the noted frame. The second threshold level TH2 should be equal to the first threshold level TH1 or larger than the first threshold level TH1. Thus, the same effect as the second example described above can be obtained.

In the embodiment described above, the structure of the display device 1 and the contents of the light emission quantity control can be modified in accordance with the spirit of the present invention, if necessary. The concrete values concerning the first, the second and the third light emission quantity control patterns are not limited to the above examples. The range of the display load factor in which the light emission quantity control is not performed substantially may be narrower or wider than the range 0-20%. It is possible to change the number of sustain pulses in accordance with the display load factor over the whole range including potential display load factors.

It is possible to control the light emission quantity in accordance with a value of other parameter instead of the average display load factor and the instantaneous display load factor. For example, it is possible to detect and accumulate discharge current of the sustain discharge, and to use two or more light emission quantity control patterns selectively for displaying an image in accordance with a comparison between a mean value of power consumption during a predetermined period (actual result) and a power consumption value corresponding to the instantaneous display load factor (theoretical value).

The present invention can be applied to driving other display devices including a CRT and a liquid crystal display panel without limiting to the plasma display panel. Power consumption can be regulated by changing intensity of an electron beam that excites fluorescent materials for the CRT or by changing luminance of a backlight for the liquid crystal display panel.

The present invention contributes to improving performances of various types of display devices.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A method for driving a display device with a light emission quantity control for regulating power consumption, the method comprising the steps of:
setting a plurality of light emission quantity control patterns for associating a value of a measurement parameter corresponding to brightness of each frame of an original image with a value of a control parameter that determines light emission quantity of an entire screen of one frame, and
performing the light emission quantity control by selectively using one of the plurality of light emission quantity control patterns that satisfies a preset selection condition in accordance with a sum of values of the measurement parameters determined for a plurality of frames.

2. The method according to claim 1, wherein the measurement parameter is a display load factor or electric power.

3. A device for driving a display device with a light emission quantity control for regulating power consumption, the device comprising first and second light emission quantity control patterns for associating a value of a display load factor corresponding to brightness of each frame of an original image with the number of drive pulses that determines light emission quantity of an entire screen of one frame, wherein
the first light emission quantity control pattern is a pattern such that a value of the number of drive pulses is decreased along with increase of the display load factor so that the power consumption becomes a constant value when a value of the display load factor is a predetermined value or more,
the second light emission quantity control pattern is a pattern in which a value of the number of drive pulses corresponding to a heavy load part in a range that includes possible values of the display load factor is larger than that of the first light emission quantity control pattern, and
if a value of the display load factor of a noted frame is larger than a mean value of the display load factors in a plurality of frames, the second light emission quantity control pattern is used for displaying the noted frame, and
if the value of the display load factor of the noted frame is smaller than the mean value, the first light emission quantity control pattern is used for displaying the noted frame.

4. The device according to claim 3, wherein the second light emission quantity control pattern is a pattern such that a difference of the number of drive pulses between the second light emission quantity control pattern and the first light emission quantity control pattern is increased along with an increase of the display load factor.

5. The device according to claim 3, further comprising a third light emission quantity control pattern in which a value of the number of drive pulses corresponding to a light load part in a range that includes possible values of the display load factor is larger than that of the first light emission quantity control pattern, wherein
if the mean value is smaller than or equal to a first threshold level and if the value of the display load factor of the noted frame is larger than the mean value, the second light emission quantity control pattern is used for displaying the noted frame,
if the mean value is smaller than or equal to the first threshold level and if the value of the display load factor of the noted frame is smaller than the mean value, the first light emission quantity control pattern is used for displaying the noted frame,
if the mean value is larger than or equal to a second threshold level that is equal to or larger than the first threshold level and if the value of the display load factor of the noted frame is smaller than the mean value, the third light emission quantity control pattern is used for displaying the noted frame, and
if the mean value is larger than or equal to the second threshold level and if the value of the display load factor of the noted frame is larger than the mean value, the first light emission quantity control pattern is used for displaying the noted frame.
